(19) United States
(12) Patent Application Publication
(10) Pub. No.: US 2026/0115933 A1
(43) Pub. Date: Apr. 30, 2026

(54) ROBOT CONTROL DEVICE AND CONTROL METHOD

(71) Applicant: SEIKO EPSON CORPORATION, Tokyo (JP)

(72) Inventor: Naoki OGASAWARA, MATSUMOTO-SHI (JP)

(21) Appl. No.: 19/369,939

(22) Filed: Oct. 27, 2025

(30) Foreign Application Priority Data
Oct. 28, 2024 (JP) 2024-189182

(51) Int. Cl. B25J 13/06

(52) U.S. Cl. CPC B25J 13/06

(57) ABSTRACT

A robot control device for controlling an operation of a robot includes a first processing unit configured to execute a control program including a startup program for starting up the robot control device, and a second processing unit configured to perform signature verification on the startup program, in which the signature verification of the startup program by the second processing unit and the execution, by the first processing unit, of the startup program that is being subjected to the signature verification by the second processing unit are performed in a temporally overlapping manner.

### CROSS-REFERENCE TO RELATED APPLICATIONS

The present application is based on, and claims priority from JP Application Serial Number 2024-189182, filed October 28, 2024, the disclosure of which is hereby incorporated by reference herein in its entirety.

### BACKGROUND OF THE INVENTION

### 1. Technical Field

The present disclosure relates to a robot control device and a control method.

### 2. Related Art

In recent years, in factories, due to a steep rise in labor costs and a shortage of human resources, work which has been manually performed has been automated by various robots and robot peripheral devices thereof. The operation of the robot is controlled by a robot control device. The robot control device includes a storage unit in which various programs are stored and a processing unit that executes the programs stored in the storage unit. The various programs include a startup program for starting up the robot control device, a driving program for driving the robot, and the like.

In such a robot control device, from the viewpoint of improving safety, it is preferable to confirm whether or not the various programs are in an appropriate state, in particular, whether or not the programs have not been tampered with due to external attacks or the like at the time of the startup of the robot control device. As this method, a method is known in which various programs are digitally signed and stored, and the signatures of the various programs are verified at the time of startup, thereby detecting the validity of the programs including whether they have been tampered with.

For example, in an information processing apparatus described in JP-A-2019-175000, signature verification is performed one by one for each stored program, and when the signature verification is successful, the program is started. This operation is performed for each program.

This makes it possible to start up each program after confirming that the program has not been tampered with, thereby ensuring safety.

However, in a method described in JP-A-2019-175000, signature verification and execution are sequentially performed for one program, and this processing is performed for each program one by one. For this reason, it takes time to start execution of each program, and in particular, it takes a long time to start up the robot control device.

### SUMMARY OF THE INVENTION

A robot control device of the present disclosure is a robot control device for controlling an operation of a robot includes a first processing unit configured to execute a control program including a startup program for starting up the robot control device, and a second processing unit configured to perform signature verification on the startup program, in which the signature verification of the startup program by the second processing unit and the execution, by the first processing unit, of the startup program that is being subjected to the signature verification by the second processing unit are performed in a temporally overlapping manner.

A control method of the present disclosure is a control method of a robot control device for controlling an operation of a robot, the control method including executing a control program including a startup program for starting up the robot control device by a first processing unit, and performing signature verification on the startup program by a second processing unit different from the first processing unit, in which the executing and the performing of the signature verification are performed in a temporally overlapping manner.

### BRIEF DESCRIPTION OF DRAWINGS

FIG. 1 is a diagram showing an overall configuration of a robot system including a robot control device according to a first embodiment of the present disclosure.

FIG. 2 is a block diagram of the robot system shown in FIG. 1.

FIG. 3 is a hardware configuration diagram of the robot control device shown in FIG. 1.

FIG. 4 is a diagram showing a control program stored in a storage unit of the robot control device shown in FIG. 1.

FIG. 5 is a time chart when the robot control device shown in FIG. 1 executes a startup program.

FIG. 6 is a time chart when the robot control device shown in FIG. 1 executes an operation program.

FIG. 7 is a flowchart for explaining a control method (signature verification success) performed by the robot control device shown in FIG. 1.

FIG. 8 is a flowchart for explaining a control method (signature verification failure) performed by the robot control device shown in FIG. 1.

FIG. 9 is a hardware configuration diagram of a robot control device according to a second embodiment of the present disclosure.

### DETAILED DESCRIPTION OF THE INVENTION

### First Embodiment

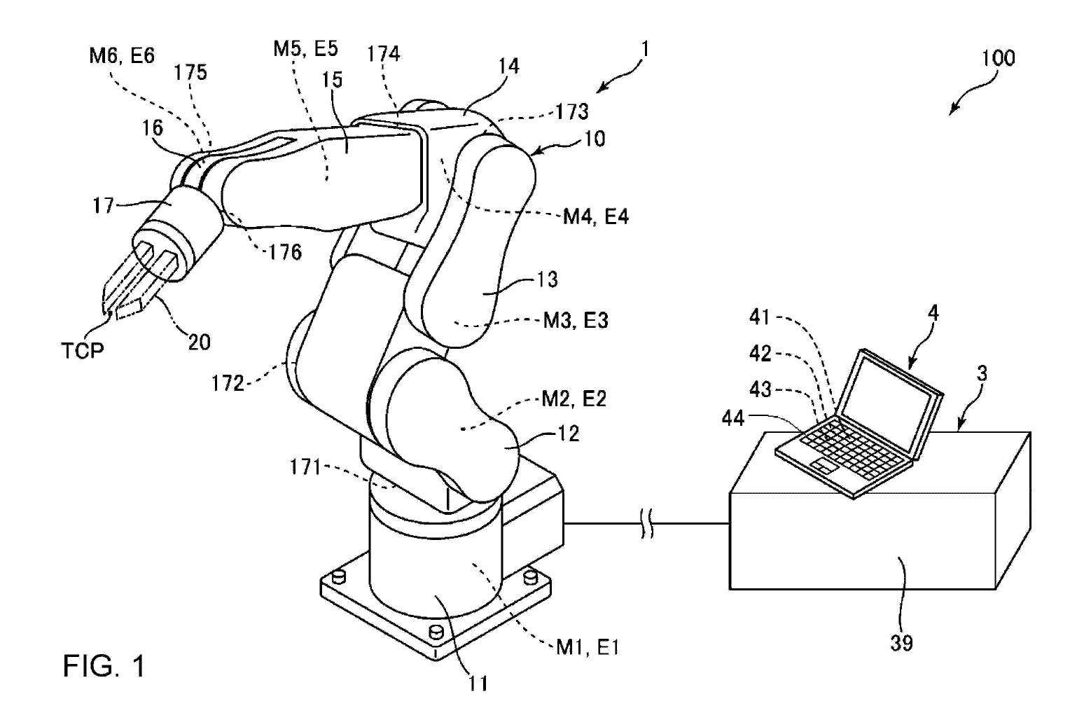

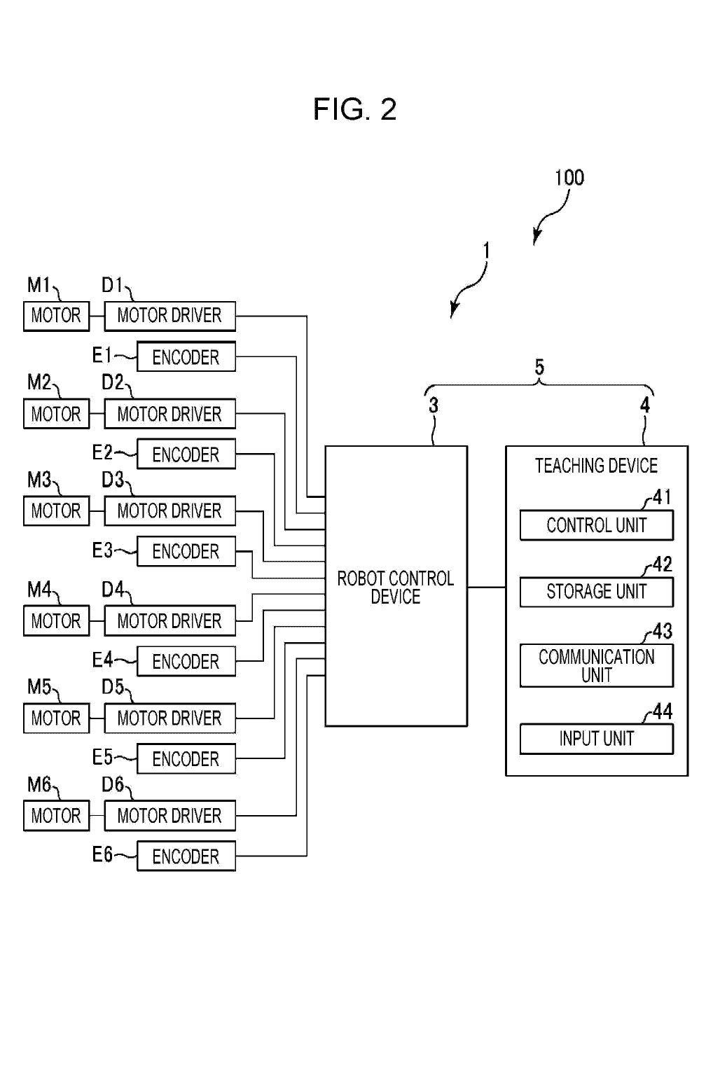

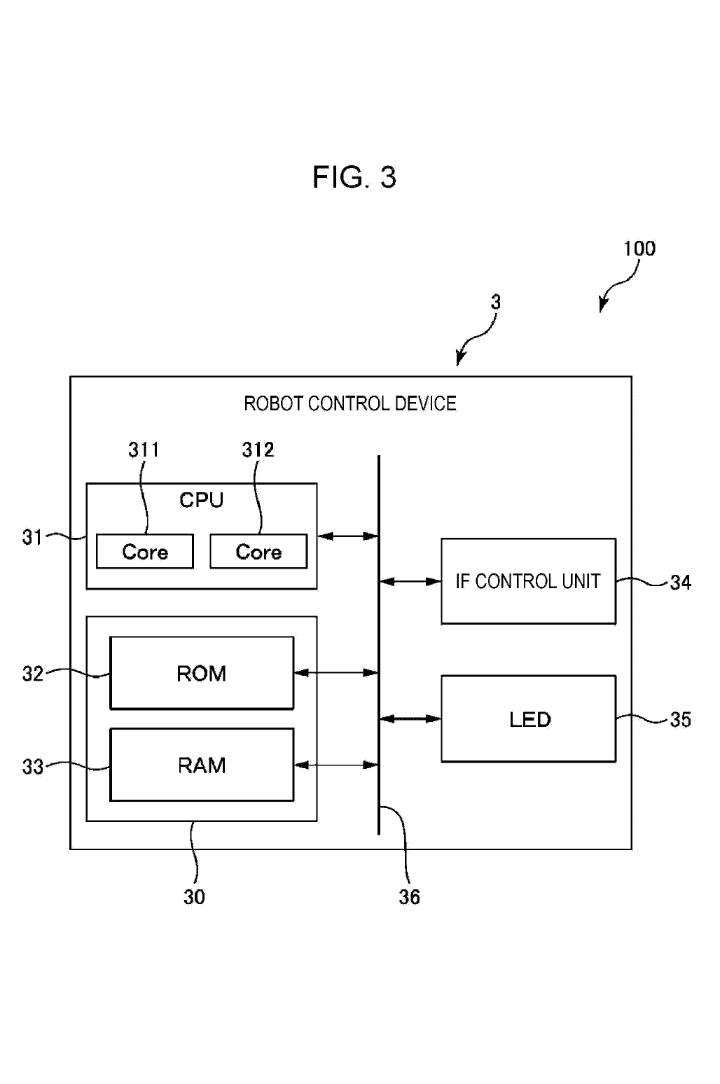

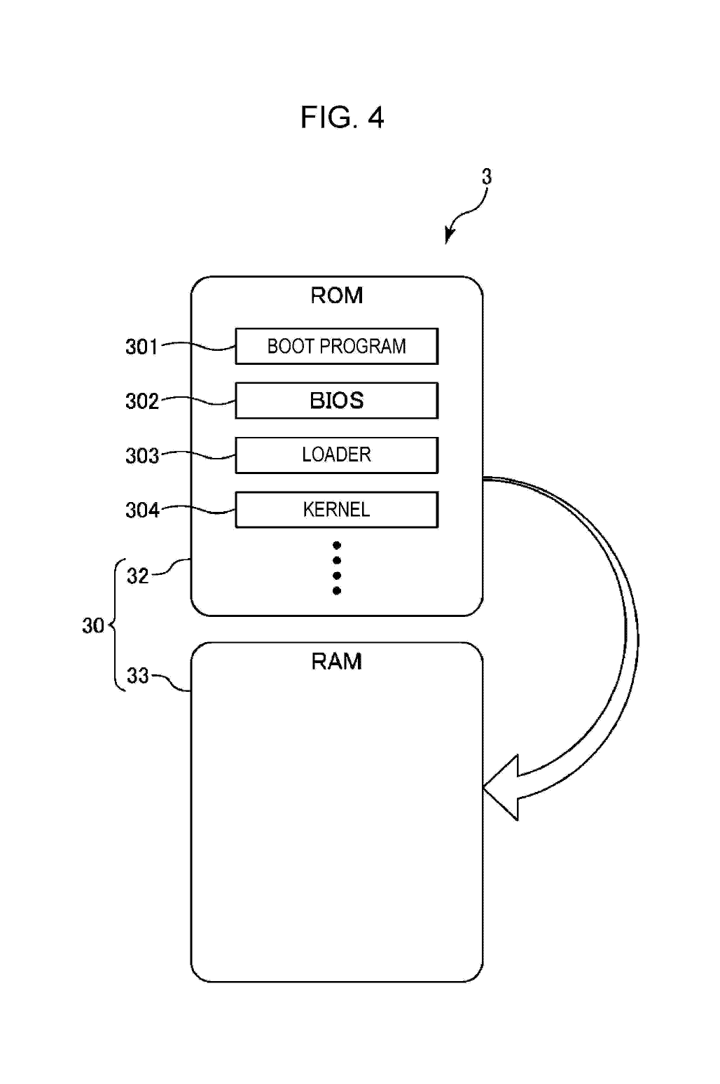

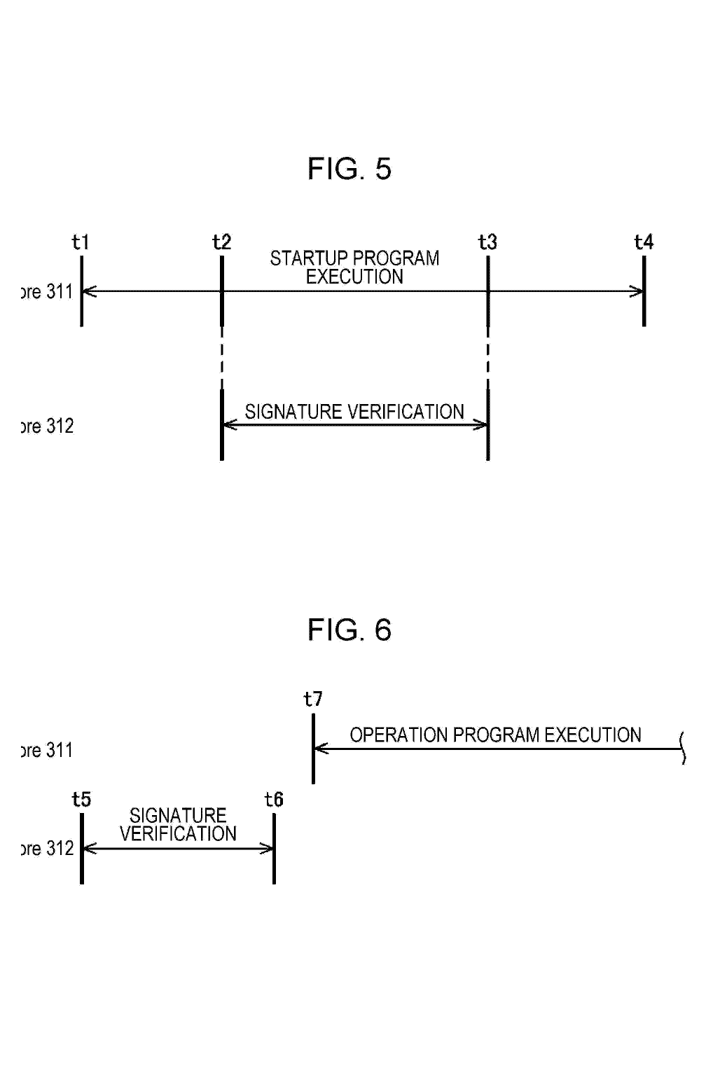

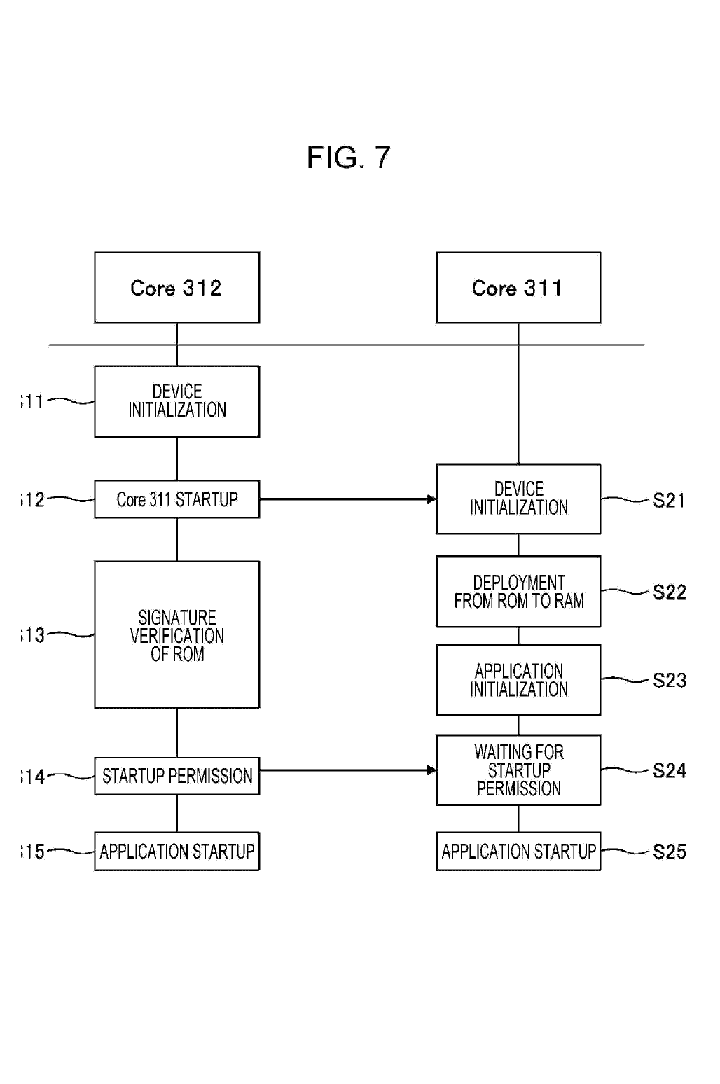

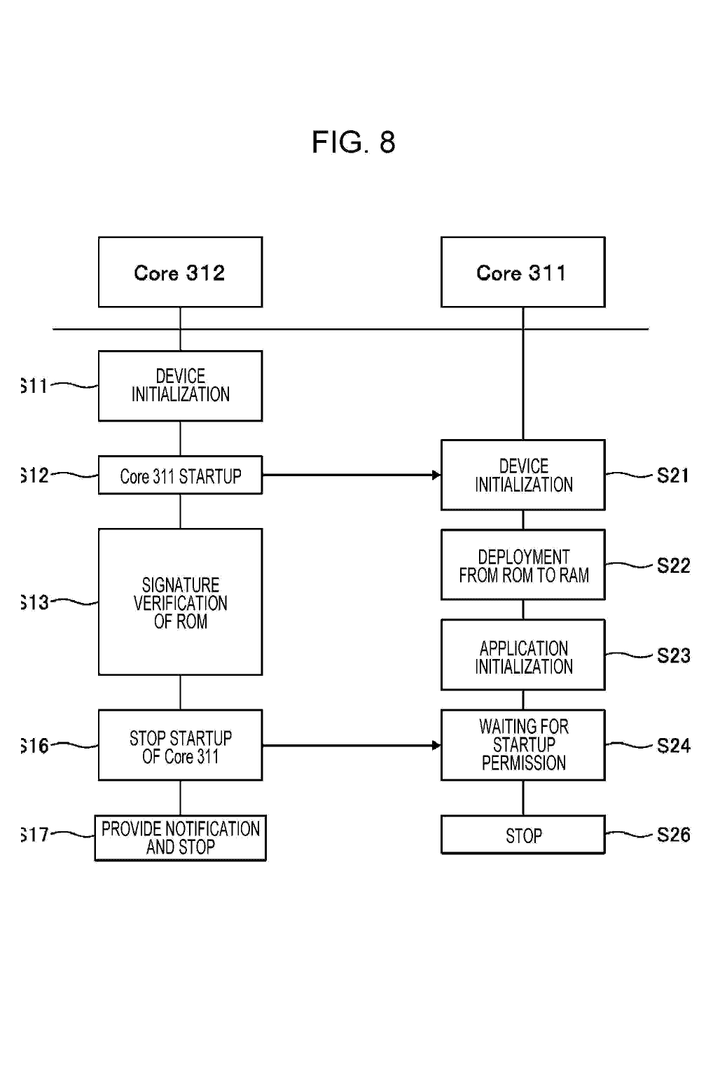

FIG. 1 is a diagram showing an overall configuration of a robot system including a robot control device according to a first embodiment of the present disclosure. FIG. 2 is a block diagram of the robot system shown in FIG. 1. FIG. 3 is a hardware configuration diagram of the robot control device shown in FIG. 1. FIG. 4 is a diagram showing a control program stored in a storage unit of the robot control device shown in FIG. 1. FIG. 5 is a time chart when the robot control device shown in FIG. 1 executes a startup program. FIG. 6 is a time chart when the robot control device shown in FIG. 1 executes an operation program. FIG. 7 is a flowchart for explaining a control method (signature verification success) performed by the robot control device shown in FIG. 1. FIG. 8 is a flowchart for explaining a control method (signature verification failure) performed by the robot control device shown in FIG. 1.

Hereinafter, a robot control device and a control method according to the present disclosure will be described in detail based on preferred embodiments shown in the accompanying drawings. For convenience of description, in a robot arm, a base 11 side in FIG. 1 is also hereinafter referred to as a "proximal end", and the opposite side, that is, an end effector 20 side, is also hereinafter referred to as a "distal end".

As shown in FIG. 1, a robot system 100 includes a robot 1, a robot control device 3 that controls an operation of the robot 1, and a teaching device 4.

First, the robot 1 will be described.

The robot 1 shown in FIG. 1 is a single-arm six-axis vertical articulated robot in the present embodiment and includes the base 11 and a robot arm 10. The end effector 20 can be attached to a distal end portion of the robot arm 10. The end effector 20 may be a constituent element of the robot 1 or may not be a constituent element of the robot 1.

The robot 1 is not limited to the shown configuration, and may be, for example, a dual-arm articulated robot. Furthermore, the robot 1 may be a horizontal articulated robot.

The base 11 is a support body that supports the robot arm 10 from a lower side in FIG. 1 such that the robot arm 10 can be driven, and is fixed to, for example, a floor in a factory. In the robot 1, the base 11 is electrically coupled to the robot control device 3 via a relay cable. The coupling between the robot 1 and the robot control device 3 is not limited to a wired coupling as in the configuration shown in FIG. 1. For example, the coupling may be wireless or may be established via a network such as the Internet.

In the present embodiment, the robot arm 10 includes a first arm 12, a second arm 13, a third arm 14, a fourth arm 15, a fifth arm 16, and a sixth arm 17, and these arms are joined in this order from the base 11 side. The number of arms included in the robot arm 10 is not limited to six and may be, for example, one, two, three, four, five, or seven or more. The size such as the total length of each arm is not particularly limited, and can be appropriately set.

The base 11 and the first arm 12 are joined via a joint 171. Then, the first arm 12 is rotatable about a first rotation axis parallel to the vertical direction with respect to the base 11, with the first rotation axis serving as a center of rotation. The first rotation axis coincides with a normal line of a floor to which the base 11 is fixed.

The first arm 12 and the second arm 13 are joined via a joint 172. Then, the second arm 13 is rotatable about a second rotation axis parallel to the horizontal direction with respect to the first arm 12. The second rotation axis is orthogonal to an axis orthogonal to the first rotation axis.

The second arm 13 and the third arm 14 are joined via a joint 173. Then, the third arm 14 is rotatable about a third rotation axis parallel to the horizontal direction with respect to the second arm 13. The third rotation axis is parallel to the second rotation axis.

The third arm 14 and the fourth arm 15 are joined via a joint 174. Then, the fourth arm 15 is rotatable about a fourth rotation axis parallel to the center axis direction of the third arm 14 with respect to the third arm 14. The fourth rotation axis is orthogonal to the third rotation axis.

The fourth arm 15 and the fifth arm 16 are joined via a joint 175. Then, the fifth arm 16 is rotatable about a fifth rotation axis with respect to the fourth arm 15. The fifth rotation axis is orthogonal to the fourth rotation axis.

The fifth arm 16 and the sixth arm 17 are joined via a joint 176. Then, the sixth arm 17 is rotatable about a sixth rotation axis with respect to the fifth arm 16. The sixth rotation axis is orthogonal to the fifth rotation axis.

In addition, the sixth arm 17 is a robot distal end portion positioned at the most distal end side of the robot arm 10. The sixth arm 17 can be rotated together with the end effector 20 through the driving of the robot arm 10.

The robot 1 includes motors M1, M2, M3, M4, M5, and M6 as drive units, and encoders E1, E2, E3, E4, E5, and E6. The motor M1 is built into the joint 171 and rotates the base 11 and the first arm 12 relative to each other. The motor M2 is built into the joint 172 and rotates the first arm 12 and the second arm 13 relative to each other. The motor M3 is built into the joint 173 and rotates the second arm 13 and the third arm 14 relative to each other. The motor M4 is built into the joint 174 and rotates the third arm 14 and the fourth arm 15 relative to each other. The motor M5 is built into the joint 175 and rotates the fourth arm 15 and the fifth arm 16 relative to each other. The motor M6 is built into the joint 176 and rotates the fifth arm 16 and the sixth arm 17 relative to each other.

In addition, the encoder E1 is built into the joint 171 and detects a position of the motor M1. The encoder E2 is built into the joint 172 and detects a position of the motor M2. The encoder E3 is built into the joint 173 and detects a position of the motor M3. The encoder E4 is built into the joint 174 and detects a position of the motor M4. The encoder E5 is built into the fifth arm 16 and detects a position of the motor M5. The encoder E6 is built into the sixth arm 17 and detects a position of the motor M6.

The encoders E1 to E6 are electrically coupled to the robot control device 3, and position information of the motors M1 to M6, that is, a rotation amount is transmitted to the robot control device 3 as an electric signal. Then, based on this information, the robot control device 3 drives the motors M1 to M6 via motor drivers D1 to D6 as shown in FIG. 2. That is, controlling the robot arm 10 means controlling the motors M1 to M6.

The end effector 20 can be detachably attached to the distal end portion of the robot arm 10. In the present embodiment, the end effector 20 includes a hand with a pair of claw portions that are capable of approaching and separating from each other, and that grips and releases a workpiece with the respective claw portions. Note that the end effector 20 is not limited to the configuration shown in the drawings, and may be a hand that grips a work target (a workpiece or a tool) by suction. Further, as the end effector 20, for example, a polishing machine, a grinding machine, a cutting machine, or a coating device may be used, or a tool such as a spray gun, a screwdriver, or a wrench may be used.

The robot 1 uses such an end effector 20 and operates the robot arm 10 as desired to perform various kinds of work (hereinafter, collectively referred to as "work") such as transport, manufacturing, processing, assembly, and painting of a work object.

A control point TCP is set at the distal end of the end effector 20. In the robot system 100, by grasping a position of the control point TCP, the control point TCP can be used as a reference of control.

Next, the teaching device 4 will be described.

As shown in FIGS. 1 and 2, the teaching device 4 includes a display unit, and has a function of creating and inputting an operation program for the robot arm 10. The teaching device 4 is not particularly limited, and examples thereof include a tablet, a personal computer, a smartphone, and a teaching pendant.

Specifically, the teaching device 4 includes a control unit 41, a storage unit 42, a communication unit 43, and an input unit 44.

The control unit 41 includes, for example, a central processing unit (CPU), and reads various programs such as a teaching program stored in the storage unit 42 and the like.

The communication unit 43 transmits and receives a signal to and from the robot control device 3 using an external interface such as a wired local area network (LAN) or a wireless LAN.

The input unit 44 includes a keyboard, a mouse, a connector, an external connection terminal, and the like. A user can input or select desired information by operating, for example, a keyboard or a mouse.

Next, the robot control device 3 will be described.

As shown in FIGS. 1, 2, and 3, the robot control device 3 has a function of acquiring and storing operation information of the robot 1 and a function of controlling the operation of the robot 1.

As shown in FIG. 1, the robot control device 3 is installed at a position away from the robot 1 in the present embodiment. However, the configuration is not limited thereto, and for example, the robot control device 3 may be built in the base 11 of the robot 1.

### Hardware Configuration of Robot Control Device 3

As shown in FIGS. 1 and 3, the robot control device 3 includes a CPU 31, a ROM 32, a RAM 33, an IF control unit 34 (communication unit), a LED 35, a bus 36, and a casing 39 in which these components are housed or installed. The bus 36 couples the CPU 31, the ROM 32, the RAM 33, the IF control unit 34, and the LED 35 to each other. The storage unit 30 is constituted by the ROM 32 and the RAM 33.

In the present embodiment, the CPU 31 is constituted by a multiprocessor having a plurality of core processors. The CPU 31 has Core 311 and Core 312 as core processors. The CPU 31 executes control programs such as a startup program and an operation program, which will be described later, and integrally controls the entire system of the robot control device 3.

The Core 311 is a first processing unit that executes a control program including a startup program and an operation program, which will be described later. The Core 312 is a second processing unit that performs signature verification for the startup program and the operation program. Note that Core 312 may have a function of executing the operation program.

"Performing signature verification" refers to verifying whether a first hash value, which is obtained by applying a hash function to the startup program or the operation program, matches a second hash value, which is obtained by decrypting an electronic signature for the startup program or the operation program using a public key.

"Signature verification is successful" refers to a case where the first hash value and the second hash value are compared and the two values are the same. When the signature verification is successful, the program has not been tampered with, the robot control device 3 can be started with high safety, and the robot 1 can be safely driven.

"Signature verification fails" refers to a case where the first hash value and the second hash value are compared and the two values are different from each other. When the signature verification fails, there is a possibility that the program has been tampered with, the safety of the startup of the robot control device 3 is not guaranteed, and the safety of the driving of the robot 1 is not guaranteed.

The ROM 32 is a read only memory that stores various data such as programs. The control program includes a startup program and an operation program.

The startup program is a program for starting up the system of the robot control device 3. As shown in FIG. 4, examples of the startup program include a boot program 301, a basic input/output system (BIOS) 302, a loader 303, and a kernel 304. In other words, each of the boot program 301, the BIOS 302, the loader 303, and the kernel 304 is a startup program. The startup program may include other programs such as a native program and a Java (registered trademark) program in addition to the above-described programs.

The operation program includes a program indicating various conditions for driving the robot 1, such as a path of the control point TCP of the robot 1, a temporal posture of the robot arm 10, and speed information of the control point TCP. Each of these is an operation program.

As shown in FIG. 3, the RAM 33 is a random access memory and is a volatile memory used for temporarily storing a control program stored in the ROM 32 when the CPU 31 executes various programs. The IF control unit 34 communicates with the outside, that is, the robot 1, the teaching device 4, or the like via a network, and transmits and receives data. The LED 35 operates to light up or blink in a predetermined pattern, and notifies, for example, an abnormality in the operation of the robot 1, an abnormality in the system of the robot control device 3, or a result (failure or the like) of signature verification described later. That is, the LED 35 functions as a notification unit. The LED 35 is installed, for example, so as to be exposed on an outer surface of the casing 39 of the robot control device 3 so that the user can visually recognize the LED 35.

### Software Configuration of Robot Control Device 3

As shown in FIG. 4, the robot control device 3 includes the boot program 301, the BIOS 302, the loader 303, the kernel 304, and various operation programs, as software modules. The boot program 301 is a program for executing a series of processes to be executed until an operating system (OS) becomes operable after the power of the robot control device 3 is turned on. The BIOS 302 is an initialization program for initializing hardware such as the ROM 32 and the IF control unit 34. "Performing initialization" or "initialize" refers to erasing data in the cache area. The loader 303 is a load program for deploying the startup program from the ROM to the RAM. The kernel 304 manages an execution state of the program in operation and manages hardware so that the program can use the functions of the hardware.

In the related art, when starting up the device, signature verification is performed on a software module A corresponding to the boot program 301, if the signature verification is successful, the software module A is executed. Next, signature verification is performed on a software module B corresponding to the BIOS 302, and if the signature verification is successful, the software module B is executed. Since such processing is repeatedly performed for each startup program, it takes time to start up the device. In contrast, according to the present disclosure, the robot control device 3 can be started quickly and safely by performing the following processing.

### Execution of Startup Program

When a power supply (not shown) is turned on, the Core 311 of the robot control device 3 starts execution of the boot program 301 (time t1 in FIG. 5). Next, the Core 312 starts signature verification of the boot program 301 (time t2 in FIG. 5). After the signature verification of the boot program 301 by the Core 312 is completed, that is, after the signature verification is successful (time t3 in FIG. 5), the execution of the boot program 301 by the Core 311 is completed (time t4 in FIG. 5). In this way, in the robot control device 3, the signature verification of the startup program by the Core 312 and the execution, by the Core 311, of the startup program that is being subjected to the signature verification by the Core 312 are performed in a temporally overlapping manner (hereinafter, referred to as "overlapping processing"). That is, the signature verification is performed in parallel during the execution of the boot program 301 in the robot control device 3. As a result, it is possible to shorten the time until the execution of the boot program 301 is completed as compared with the related art. Therefore, it is possible to start up the robot control device 3 quickly.

In the robot control device 3, as with the above, the execution by the Core 311 and the signature verification by the Core 312 are also performed in a temporally overlapping manner with respect to the BIOS 302, the loader 303, and the kernel 304. Accordingly, it is possible to start up the robot control device 3 more quickly.

In the present embodiment, the execution by the Core 311 and the signature verification by the Core 312 are performed in a temporally overlapping manner for all startup programs, but the present disclosure is not limited to this, and the effects of the present disclosure can be sufficiently exhibited if the execution by the Core 311 and the signature verification by the Core 312 are performed in a temporally overlapping manner for at least one startup program. In this case, it is preferable to preferentially perform the overlapping processing for the startup program that requires a long time to start up among all the startup programs.

As described above, after the Core 311, as the first processing unit, starts the execution of the startup program, the Core 312, as the second processing unit, starts the signature verification of the startup program. As a result, since the time from the start to the completion of the signature verification of the startup program tends to be shorter than that of the execution of the startup program, the execution of the startup program by the Core 311 is started first, thereby the time can be more effectively reduced by the overlapping processing of the execution by the Core 311 and the signature verification by the Core 312. Therefore, it is possible to start up the robot control device 3 more quickly.

The execution of the startup program by the Core 311 and the signature verification of the startup program by the Core 312 may be started at the same time, or the signature verification of the startup program by the Core 312 may be started earlier.

When the signature verification by the Core 312 fails, the execution of the startup program is stopped, and the LED 35 operates, for example, to blink so as to notify the failure of the signature verification. As a result, it is possible to prevent the robot control device 3 from being started even though there is a possibility that the startup program has been tampered with. Even when the signature verification by the Core 312 fails, the execution of all or part of the startup program may be continued. In this case, it is preferable to perform notification by the LED 35 at the time when the signature verification fails.

In addition, even when the signature verification of the startup program by the Core 312 is successful, the LED 35 may be operated to notify the success. In this case, the LED 35 may be operated in a mode different from the mode (blinking) when the signature verification fails, for example, in a manner in which the LED 35 lights up for a certain period of time.

### Execution of Operation Program

When the signature verification of the startup program by the Core 312 is successful, the operation program is in an executable state. When the operation program is executed, first, the Core 312 starts the signature verification of the operation program (time t5 in FIG. 6). When the signature verification of the operation program by the Core 312 is completed, that is, when the signature verification is successful (time t6 in FIG. 6), the Core 311 starts execution of the operation program after a predetermined time (time t7 in FIG. 6). As described above, with respect to the operation program, overlapping processing with signature verification of the operation program is not performed, and the operation program is executed on the condition that the signature verification of the operation program is successful. As a result, it is possible to prevent execution of an inappropriate operation program that may have been tampered with, thereby ensuring safety. In particular, since the operation program is for operating the robot arm 10 in many cases, higher safety is required as compared with the startup program. Therefore, such a configuration is effective.

As described above, the control program includes the operation program for operating the robot 1, and the Core 312 as the second processing unit performs the signature verification for the operation program, after the signature verification is successful and after the startup of the robot control device 3, the Core 311 as the first processing unit executes the operation program. Accordingly, it is possible to operate the robot 1 in a state where high safety is ensured.

Depending on the content of the operation program, overlapping processing may be performed as in the startup program, that is, in a configuration in which the execution by the Core 311 and the signature verification by the Core 312 are performed in a temporally overlapping manner.

In this case, among all the operation programs, for example, in an initial stage of the execution of the operation program, such as the setting, confirmation, and adjustment of an initial position of the control point TCP, overlapping processing can be performed for the operation program in which safety is relatively ensured in consideration of the operation content.

When the signature verification of the operation program by the Core 312 fails, the operation program is not executed, and a notification that the signature verification has failed is provided by the operation of the LED 35 (for example, blinking). As a result, the user can recognize that there is a possibility that the operation program has been tampered with, and can take a predetermined action such as stopping the execution of the operation program.

Even when the signature verification of the operation program by the Core 312 is successful, a notification that the signature verification has succeeded may be provided by the operation of the LED 35. In this case, the LED 35 may be operated in a mode different from the mode (blinking) when the signature verification fails, for example, in a manner in which the LED 35 lights up for a certain period of time.

In addition, the notification of the result (success or failure) of the signature verification by the operation of the LED 35 may be the same or different between the startup program and the operation program. In addition, the notification of the result of the signature verification is not limited to the operation of the LED 35, and may be performed, for example, by a display by a display unit other than the LED 35, or by voice. Examples of the display unit other than the LED 35 include a liquid crystal display, for example, a liquid crystal display included in the teaching device 4.

As described above, the robot control device 3 is a robot control device that controls the operation of the robot 1, includes the Core 311 as the first processing unit that executes a control program including a startup program that starts up the robot control device 3, and the Core 312 as the second processing unit that performs signature verification of the startup program, and performs the signature verification of the startup program by the Core 312 and the execution of the startup program, which is being subjected to signature verification by the Core 311, by the Core 311, in a temporally overlapping manner. Thus, it is possible to start up the robot control device 3 quickly and safely.

Although the case where the Core 311 and the Core 312 exist in the same CPUs has been described in the present embodiment, the present disclosure is not limited to this, and the Core 311 and the Core 312 may exist in different CPUs.

The robot control device 3 includes the storage unit 30 having the ROM 32 and the RAM 33, and the IF control unit 34 as a communication unit that communicates with the robot 1. The startup program is stored in the ROM 32, and includes at least one (both in the present embodiment) of the BIOS 302 as an initialization program that initializes the storage unit 30 (ROM 32 and RAM 33) and the IF control unit 34 and the loader 303 as a load program that deploys the startup program from the ROM 32 to the RAM 33 of the storage unit 30. Since the BIOS 302 and the loader 303 tend to take a relatively long time to execute, the effect of the present disclosure can be more remarkably exhibited by performing the execution and the signature verification on the BIOS 302 and the loader 303 in a temporally overlapping manner.

In the present embodiment, a configuration in which execution and signature verification are performed in a temporally overlapping manner for both the BIOS 302 and the loader 303 has been described, but the present disclosure is not limited to this, and a configuration in which execution and signature verification are performed in a temporally overlapping manner for only one of BIOS 302 and the loader 303 may be adopted.

Next, examples of the control method of the present disclosure will be described with reference to the flowcharts shown in FIGS. 7 and 8. Hereinafter, a case where the execution and the signature verification are performed on only the loader 303 in a temporally overlapping manner will be described.

First, a case where the signature verification is successful will be described with reference to FIG. 7.

When a power supply (not shown) is turned on, the Core 312 initializes devices (hardware) in Step S11. Then, the Core 312 starts up the Core 311 (Step S12), and the Core 311 initializes the devices (Step S21). That is, the Core 311 reads the boot program 301 and the BIOS 302 from the ROM 32 and executes them. Next, the Core 311 reads and executes the loader 303 from the ROM 32, and performs processing of deploying the control program stored in the ROM 32 to the RAM 33 (Step S22: Execution Step). On the other hand, the Core 312 performs the signature verification of the control program stored in the ROM 32 (Step S13: Signature Verification Step). The signature verification of the loader 303 in Step S13 and Step S22 are performed in a temporally overlapping manner. This contributes to the quick startup of the robot control device 3.

The Core 311 initializes the application during the signature verification (Step S23). That is, each startup program is initialized, and then, in Step S24, startup permission of each startup program is awaited.

When all signature verifications are successful, the Core 312 permits the Core 311 to start (Step S14). Then, in Step S15 and Step S25, the Core 311 and the Core 312 start up the application. That is, the system of the robot control device 3 is started to bring the robot 1 into a controllable state.

Next, a case where the signature verification of the startup program fails will be described with reference to FIG. 8.

Since steps S11 to S13 and steps S21 to S24 are the same as those in the case where the signature verification of the startup program is successful, the description thereof will be omitted, and only steps S16, S17, and S26 will be described.

When the signature verification in Step S13 fails, in Step S16, the Core 312 transmits a signal to the Core 311 to immediately stop the startup of the Core 311, and the Core 311 stops the execution of the startup program (Step S26). After the Core 312 stops the startup of Core 311, the Core 312 provides a notification and stops (Step S17). This notification is performed by operating (blinking) the LED 35 in a predetermined pattern.

As described above, the control method is a control method of the robot control device 3 for controlling the operation of the robot 1, and includes an execution step in which the Core 311 as the first processing unit executes the control program including the startup program that starts up the robot control device 3, and a signature verification step in which the Core 312 as the second processing unit different from the Core 311 performs the signature verification of the startup program. The execution step and the signature verification step are performed in a temporally overlapping manner. Thus, it is possible to start up the robot control device 3 quickly and safely.

### Second Embodiment

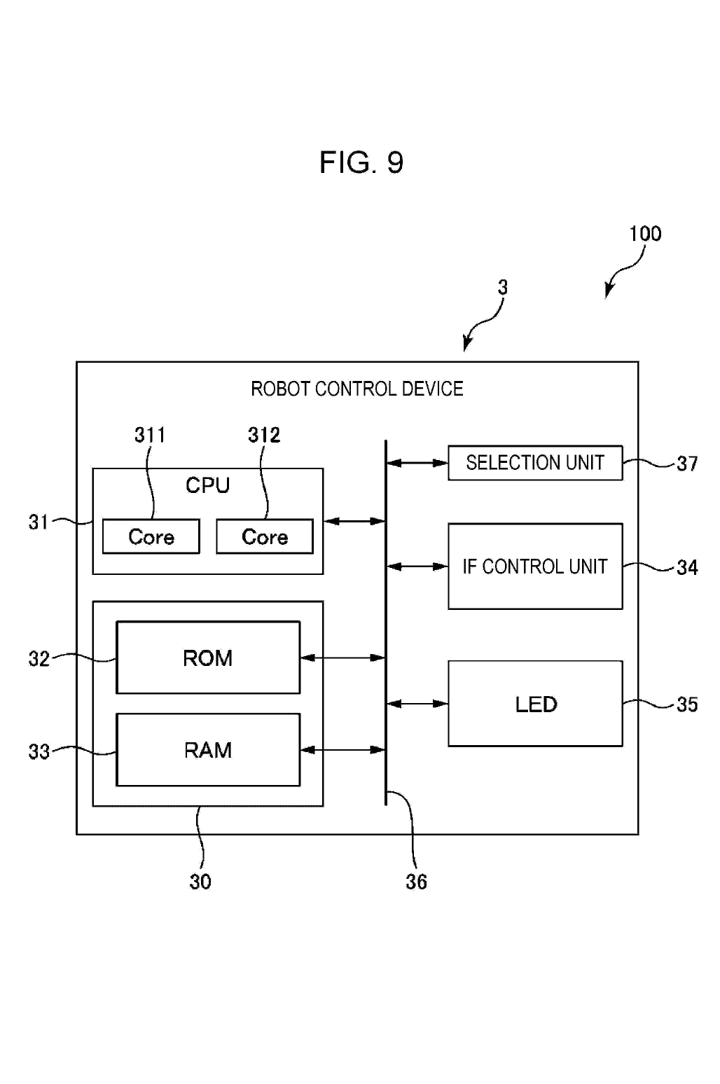

FIG. 9 is a hardware configuration diagram of a robot control device according to a second embodiment of the present disclosure.

Hereinafter, the second embodiment of the robot control device and the control method according to the present disclosure will be described with reference to FIG. 9, but hereinafter, differences from the first embodiment will be mainly described, and the description of the same matters will be omitted.

As shown in FIG. 9, the robot control device 3 includes a selection unit 37 that selects a first mode and a second mode. The first mode is a mode in which the execution of the startup program by the Core 311 and the signature verification of the startup program by the Core 312 are performed in a temporally overlapping manner as described in the first embodiment. The second mode is a mode in which the Core 311 executes the startup program after the signature verification of the startup program by the Core 312 is successful.

The selection unit 37 includes, for example, a CPU, and is coupled to the CPU 31, the ROM 32, the RAM 33, the IF control unit 34 (communication unit), and the LED 35 via the bus 36. When the user selects and inputs the first mode or the second mode using, for example, the input unit 44 of the teaching device 4 shown in FIGS. 1 and 2 or another input device (not shown), the input mode is set. Then, the CPU 31 reads and executes a program corresponding to the set mode (the first mode or the second mode). To be more specific, although not shown, a first program for executing the first mode and a second program for executing the second mode are stored in the ROM 32, the selection unit 37 transmits a signal for executing the first mode or a signal for executing the second mode to the CPU 31, and the CPU 31 executes a corresponding program in response to the signal.

When the selection unit 37 selects the first mode, the control as described in the first embodiment is performed. The advantages of the first mode are as described above. When the selection unit 37 selects the second mode, the signature verification of the startup program by the Core 312 and the execution of the startup program by the Core 311 are sequentially performed for the boot program 301, the BIOS 302, the loader 303, the kernel 304, and the various operation programs, respectively. That is, in the second mode, the signature verification and execution are performed without temporal overlap. Advantages of the second mode include simplified control processing and higher safety.

In this way, by selecting and executing one of the first mode and the second mode, it is possible to select whether to prioritize the speed of startup or to prioritize high safety and simplification of the control processing. Therefore, the user can select an appropriate mode in consideration of various conditions such as the work content of the work to be performed by the robot 1, the work level, the importance of the work, the work time (speed of the work), the work frequency, the work time interval from the previous work, and the possibility of tampering with the control program (particularly, the startup program and the operation program). Therefore, convenience can be improved.

In the present embodiment, the selection unit 37 is configured by a CPU separate from the CPU 31, but the present disclosure is not limited to this, and the selection unit 37 may exist in the CPU 31.

As described above, the robot control device 3 includes the selection unit 37 that selects the first mode in which the execution of the startup program by the Core 311 as the first processing unit and the signature verification of the startup program by the Core 312 as the second processing unit are performed in a temporally overlapping manner, and the second mode in which the Core 311 executes the startup program after the signature verification of the startup program by the Core 312 is successful. Thus, convenience can be improved.

The robot control device 3 may be configured to be able to select a mode (third mode) other than the first mode and the second mode. The modes other than the first mode and the second mode include, for example, a mode in which a control program for performing signature verification and execution in a temporally overlapping manner can be selected.

In the present embodiment, the selection and input of the first mode or the second mode is configured to be performed by the operation of the user. However, the present disclosure is not limited to this, and the selection of the mode may be automatically performed and set, for example, according to the various conditions described above.

In addition, when the work is performed by the robot 1, the selection of the mode is not limited to the case where the user selects the mode each time, and for example, a configuration may be adopted in which the previous mode is continued as it is unless the mode change operation is performed. Accordingly, there is an advantage that time and effort of the selection work by the user are reduced while sufficient safety is ensured.

In addition, when the work is performed by the robot 1, a configuration may be adopted in which the first mode is preferentially selected from the first mode and the second mode, and only in a case where the user cancels the selection, the second mode can be selected. Accordingly, there is an advantage that time and effort of the selection work by the user are reduced while sufficient safety is ensured.

In addition, it is also possible to adopt a configuration in which the selectable mode between the first mode and the second mode is restricted in accordance with the history of the signature verification result of the startup program or the like. For example, when there is a history of "signature verification failure" in the past, the first mode cannot be selected until a predetermined time or the number of operations has elapsed, that is, only the second mode can be selected. Thus, higher safety can be ensured. The same applies to each of the above configurations when the third mode is added.

Although the robot control device and the control method according to the present disclosure have been described with reference to the embodiments shown in the drawings, the present disclosure is not limited thereto. In addition, each unit and each process of the robot control device and the control method can be replaced with any structure or process which can exhibit the same function. Additionally, any structure or process may be added.

1. A robot control device for controlling an operation of a robot, comprising:
a first processing unit configured to execute a control program including a startup program for starting up the robot control device;
a second processing unit configured to perform signature verification on the startup program, wherein
the signature verification of the startup program by the second processing unit and the execution, by the first processing unit, of the startup program that is being subjected to the signature verification by the second processing unit are performed in a temporally overlapping manner.

2. The robot control device according to claim 1, wherein
the control program includes an operation program for operating the robot,
the second processing unit performs signature verification on the operation program, and
the first processing unit executes the operation program after the signature verification is successful and after the robot control device is started.

3. The robot control device according to claim 1, wherein
the second processing unit starts the signature verification of the startup program after the first processing unit starts the execution of the startup program.

4. The robot control device according to claim 1, further comprising:
a storage unit including a ROM and a RAM; and a communication unit configured to communicate with the robot, wherein
the startup program is stored in the ROM and includes at least one of an initialization program for initializing the storage unit and the communication unit and a load program for deploying the startup program from the ROM of the storage unit to the RAM.

5. The robot control device according to claim 1, further comprising:
a selection unit configured to select a first mode in which the execution of the startup program by the first processing unit and the signature verification of the startup program by the second processing unit are performed in a temporally overlapping manner, and
a second mode in which the first processing unit executes the startup program after the signature verification of the startup program by the second processing unit is successful.

6. A control method of a robot control device for controlling an operation of a robot, the method comprising:
executing a control program including a startup program for starting up the robot control device by a first processing unit; and
performing signature verification on the startup program by a second processing unit different from the first processing unit, wherein
the executing and the performing of the signature verification are performed in a temporally overlapping manner.
